(19) United States
(12) Patent Application Publication
(10) Pub. No.: US 2026/0174170 A1
(43) Pub. Date: Jun. 25, 2026

(54) METHOD AND APPARATUS FOR IMPROVED PROTECTIVE BUCKLE SYSTEM

(71) Applicant: Apollo Safety, Inc., Mill Valley, CA (US)

(72) Inventor: Henry Holbrook, Burbank, CA (US)

(73) Assignee: Apollo Safety, Inc., Mill Valley, CA (US)

(21) Appl. No.: 19/422,337

(22) Filed: Dec. 16, 2025

Related U.S. Application Data
(60) Provisional application No. 63/736,537, filed on Dec. 19, 2024.

(51) Int. Cl. A42B 3/04; A42B 3/08; B60R 22/48

(52) U.S. Cl. CPC A42B 3/0433; A42B 3/08; B60R 22/48; B60R 2022/4816

(57) ABSTRACT

A buckle-monitoring safety system is disclosed. In one embodiment, the system includes a buckle assembly and one or more sensors configured to detect motion, presence, or orientation of protective equipment such as a helmet. A buckle-status element determines whether first and second buckle connectors are engaged, and a processor evaluates buckle state in relation to sensed activity. When the buckle is unfastened during movement or while a user is detected, the system generates a reminder alert to encourage securing the buckle. In certain embodiments, wireless communication transmits status information or restricts activation of powered equipment unless the buckle is engaged. The system may classify activity using machine-learning models, detect strap tension levels, determine helmet-on-head conditions, and issue alerts until fastening is confirmed. The disclosed system may be integrated into a helmet, a buckle module, or retrofitted onto other protective gear.

This patent application claims priority to U.S. Provisional Patent Application Ser. No. 63/736,537 filed on Dec. 19, 2024, which is incorporated by reference herein in its entirety.

### BACKGROUND OF THE SYSTEM

Safety buckles are widely used in protective equipment such as helmets, child car seats, harnesses, sports headgear, and industrial safety gear. A properly secured buckle helps retain the equipment on the user during impact or hazardous activity. When a buckle is left unfastened, is incompletely latched, or is fastened with insufficient tension, the effectiveness of the protective equipment may be reduced or lost.

Users sometimes fail to secure buckles or inadvertently fasten them incorrectly. In the context of bicycle and motorcycle helmets, it is not uncommon for users to begin riding with a loose or unlatched buckle and chin strap system. Similar issues occur with youth sports helmets, industrial hard hats, and child passenger restraint systems, where the protective equipment may be correctly worn but the fastening mechanism is not secured.

While various protective devices exist, including helmets incorporating lights, reflectors, or impact-responsive features, many currently deployed systems do not determine whether a buckle is properly latched or tensioned while the equipment is in use. In scenarios involving bicycles, scooters, vehicles, organized athletics, or hazardous environments, a lack of buckle engagement awareness may lead to a user operating with unsecured protective gear.

### SUMMARY

The present system provides a smart buckle system configured to automatically monitor, detect, and remind a user to fasten a safety buckle on a helmet or other protective gear. The system enhances user safety by ensuring that protective headgear or other equipment is both worn and securely buckled before or during use.

In an embodiment, the smart buckle system is integrated into a helmet. The disclosed helmet system is designed to remind users to secure the helmet buckle, thereby enhancing safety during use. Traditionally, individuals would verbally remind others, such as children, to buckle their helmets. In addition, all passenger vehicles are required by law in the United States to remind riders to buckle. While helmets with integrated lights or other features have been available, these measures are ineffective if the helmet is not properly fastened. This system prioritizes ensuring that the helmet is buckled during use and optionally incorporates a self-charging mechanism to eliminate the need for external charging. The design ensures ease of use and prioritizes safety, enabling the helmet to function effectively without requiring significant user attention. While described with reference to helmets, the invention is equally applicable to any protective system requiring a secure buckle, including harnesses, child seats, or industrial safety gear.

The system provides a mechanism to remind users to secure their helmet buckle before engaging in a dangerous activity or entering a danger zone, thereby reducing the risk of injury. Using a series of logic statements and/or machine learning, the buckle system can determine whether the user is in motion (or in a dangerous location) and whether the helmet is securely buckled. Furthermore, accelerometer technologies can detect if the helmet is moving (implying that the helmet is on a user's head) and take appropriate actions as necessary, depending on accelerometer data.

### BRIEF DESCRIPTION OF THE DRAWINGS

FIG. 1 illustrates a helmet utilizing the buckle system in an embodiment.

FIG. 2 illustrates a buckle detection mechanism in an embodiment.

FIG. 3 is a flow diagram illustrating the operation of the system in an embodiment.

FIG. 4 illustrates a self-contained buckle in an embodiment.

FIG. 5 illustrates a system architecture for controlling operation of a powered device based on buckle status in an embodiment.

### DETAILED DESCRIPTION OF THE SYSTEM

In one embodiment, the system includes a buckle assembly integrated with electronic sensors, such as a GPS antenna, accelerometers, gyroscopes, magnetometers, switches and proximity or time-of-flight sensors. These components enable the system to determine whether an associated helmet is being worn, whether the buckle is properly fastened, and whether the user is in motion or within a designated hazardous zone.

For instance, if the user is travelleing on a bicycle, and the buckle is unfastened while the helmet is detected on the user's head, the system will emit an audible alert to prompt the user to secure the buckle. This system is applicable to a variety of helmeted activities, including but not limited to cycling, motorcycling, car racing, skiing, football, skateboarding, surfing, skydiving, hang gliding, hockey, and lacrosse. In team sports, the system can confirm that all players' helmets are securely fastened before practice or gameplay begins. Additionally, the system can be employed in commercial and professional environments, such as construction sites, military operations, and law enforcement, where individuals rely on hard hats for protection.

When the system detects that a helmet is being worn but the buckle is unfastened, an audible and/or visual alert is generated to remind the user or those nearby to secure the buckle. The system may also identify insufficient strap tension that could compromise protection. Power may be provided by a rechargeable or non-rechargeable battery, optionally supported by integrated solar panels to enable self-charging operation without external power sources.

The system can communicate wirelessly (e.g., via Bluetooth, LoRa, or similar radio interfaces) with external devices such as smartphones or monitoring platforms to transmit information including buckle status, user activity, or incident alerts. The system may further employ machine-learning algorithms to adapt to user behavior and environmental conditions, improving accuracy and responsiveness over time.

The system is applicable across a wide range of use cases, including but not limited to cycling, motorcycling, construction, law enforcement, military, industrial safety, and organized sports such as football, hockey, or skiing. In team or workplace environments, the system can provide collective monitoring to ensure that all participants have securely fastened their helmets or safety gear before beginning hazardous and or dangerous activities.

In certain embodiments, the buckle may also serve as an activation key for access and/or starting powered vehicles or equipment, such as electric bicycles or construction machinery, enabling operation only when the buckle is securely fastened. In the event of an accident or impact, the same sensor and communication components may automatically transmit an emergency or location alert with emergency data (like impact data or personal information) to designated third parties.

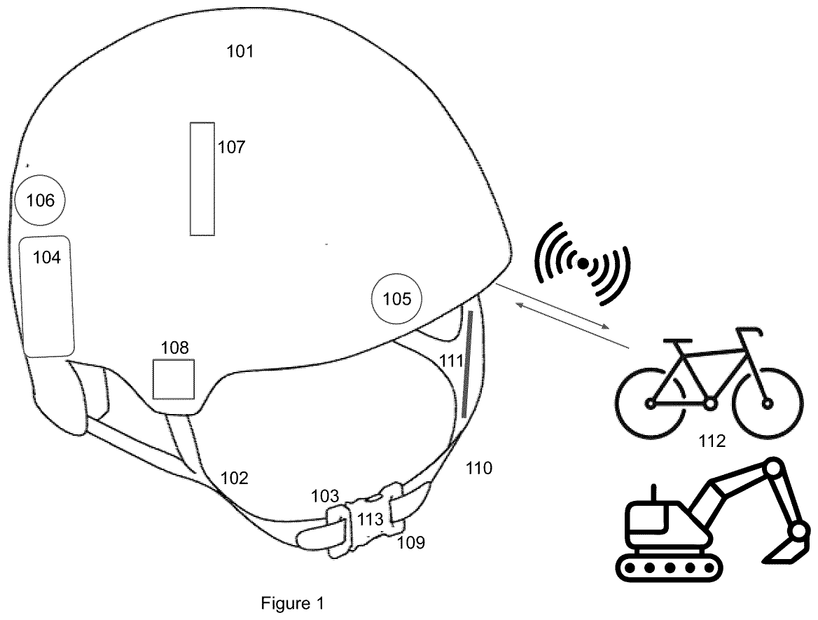

FIG. 1 illustrates an embodiment of the helmet system 100. The system 100 comprises a helmet 101 having one strap 102 terminating in a first buckle connector 103. It also includes a connection to equipment like an electric bike or bulldozer 112 (The system can be used in any situation where confirmation of the fastening of a buckle is useful, including vehicles, heavy equipment, athletics, seats, and the like). Helmet 101 includes internal electronic components 104 such as a processor or CPU, an accelerometer, gyroscope, and magnetometer, a GPS antenna, anemometer, a communications transceiver and a power source. It also comprises of lights 105, an audio output device 106, one or more solar panels 107 and switch(s) 108. A corresponding strap, 110, includes a second buckle connector 109 configured to engage buckle connector 103 to secure helmet 101 during use.

The accelerometer, gyroscope, and magnetometer 104 detect motion and orientation of helmet 101, providing up to nine-axis motion sensing in certain embodiments. A processor or control board governs all logic and operational functions of helmet 104. When the helmet senses movement, it switches the system from an OFF/sleep state to an ON/wake state. Then the system looks for the presence of a head via switch(s) either—mechanical, capacitive, time-of-flight, or infrared presence sensors. When the helmet detects motion indicative of activity while unbuckled and not buckled, a timer starts. After some period of time (e.g. 5 seconds), if it remains unbuckled, the audio output device 106 emits an audible alert and lights blink to remind the user to secure the buckle. When the buckle is properly fastened, the alerts cease and access to vehicles or an e-bike is granted or powered. GPS and other positioning systems (including Wi-Fi, LoRa, Bluetooth triangulation, etc.) may determine whether the user is within a designated hazardous area. If motion or location data indicate an unsafe condition while the helmet remains unbuckled, an alert is generated.

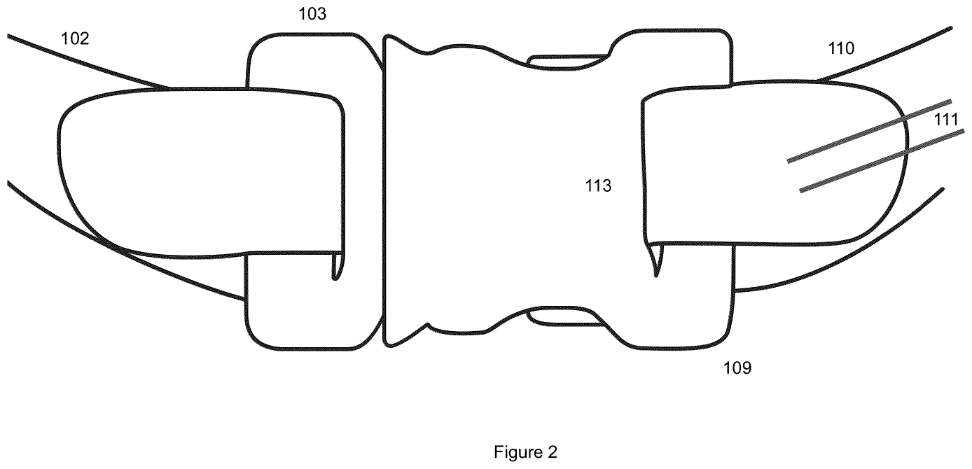

FIG. 2 illustrates an embodiment of the buckle detection mechanism. Buckle connector 103, disposed at the end of strap 102, engages corresponding buckle connector 109 on strap 110. Conductive wires 111 are embedded within the straps, creating a connection circuit. When buckle connectors 103 and 109 are disconnected, the connection circuit is open; when connected, the connection circuit is closed. The electronic components 104 detects this open or closed-circuit condition to determine buckle status. Other means of detecting open and closed circuit include a Hall-effect switch with magnetic components or a physical switch 113. If motion or location sensors indicate hazardous activity while the buckle circuit is open for longer than a preset time, the helmet emits a continuous audible and/or visual alarm until either helmet is removed, motion ceases, the hazardous location is gone or the buckle is fastened.

In certain embodiments, the system identifies not only whether the buckle is open or closed, but also whether the strap tension is sufficient for secure use. The helmet may include a tension-sensing element embedded within or attached to the chin strap. In an embodiment, the tension-sensing element comprises a strain-responsive resistive conductor, the electrical resistance of which varies proportionally with strap elongation. When tension falls below a defined threshold, processor logic may classify the buckle state as under-tightened even if the connectors remain mechanically engaged. In another embodiment, a piezoelectric strip or fiber optic filament positioned within strap material changes signal characteristics when tension decreases, allowing the system to determine an inadequately secured strap condition and optionally produce the same alert as an unbuckled state.

In an embodiment, the helmet could incorporate accelerometers and/or motion sensors to detect movement of the helmet. This movement could be the trigger to check for whether the buckle is fastened and/or is securely tightened.

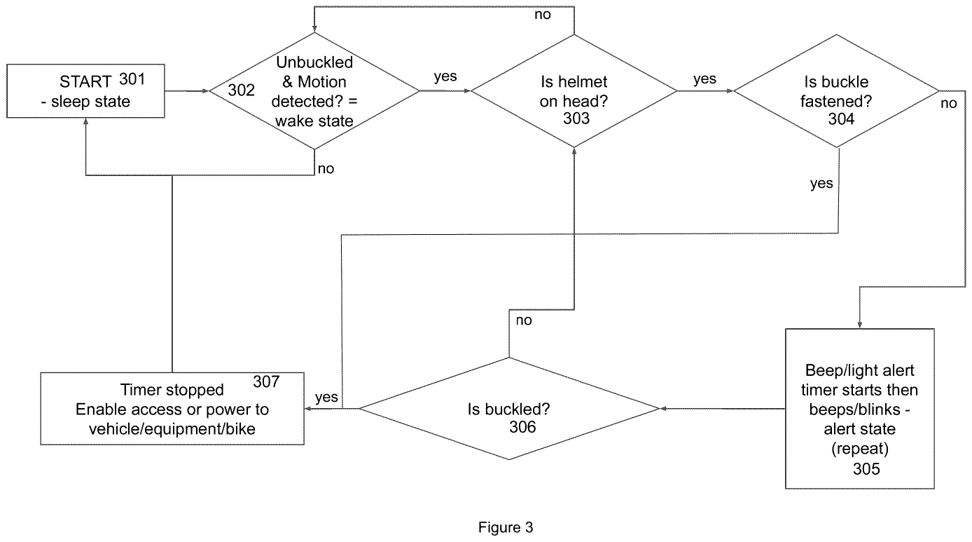

FIG. 3 is a flow diagram illustrating one embodiment of system operation. At step 301, the helmet resides in an OFF/sleep state. In many cases, a user will buckle the strap after removing the helmet, and then hang the strap on a hook, the handlebars, or some other location when the helmet is not in use. The helmet system can detect the lack of motion (from accelerometers and/or motion sensors) and put the helmet into a sleep state.

At decision block 302, it is determined if the system detects motion (such as when a user picks up the helmet from wherever it was being stowed) and/or if it detects the separation of the buckle (done by a user about to don the helmet). If these triggers are detected, the system initiates the helmet to the ON/wake state at step 302 and proceeds to step 303. If there is no detection at step 302, the system returns to step 301 and the helmet remains in the sleep state. In an embodiment, the system may maintain this wake state for a certain time period while waiting for the helmet to be buckled and/or placed on a head or for some other trigger. If the system senses motion but does not sense buckling, the system will initiate an internal timer, and enter a modified sleep state. During this modified sleep state, the system will check every 30 seconds (for example), to determine if there is buckling and/or presence on a head. This periodic checking may continue for a certain number of checks (e.g. five) and if there is still no detection of buckling or head presence, the system will return to the sleep state of step 301.

At decision block 303 it is determined if the helmet has been placed on a person's head. In an embodiment, this is accomplished via an internal pressure switch or proximity sensor. In an optional embodiment, the presence of a user's head within the helmet interior is detected by at least one internal presence-sensing element. In an embodiment, a low-profile pressure sensor is positioned configured to detect compression when the helmet rests upon a user's skull. The pressure sensor may be calibrated to detect compression above a minimum threshold, such as between 30-200 grams of force. In certain optional embodiments, head presence is detected using optical time-of-flight ranging, in which an infrared emitter and photodiode measure return reflection from hair or skin at distances less than approximately 20-40 millimeters. In other optional embodiments, a capacitive sensor detects changes in field impedance caused by conductive tissue when placed within the helmet cavity. Any of the above mechanisms, alone or in combination, may be used to determine whether a helmet is being worn.

If the helmet is on a head, the system proceeds to decision block 304. If not, the system remains in wake state at step 302. The system then begins monitoring sensor inputs and timing conditions along with potentially hazardous activities.

At decision block 304 the system determines if the buckle is fastened. If not, the system proceeds to step 305 and initiates a timer. If the buckle is fastened, the system proceeds to step 307. In an embodiment, the system emits a unique sound when the buckle is fastened, to confirm to the user that the buckle is locked and secure. This helps avoids situations where the buckle is not fully engaged and provides useful feedback to the user.

If the buckle is on a head and remains open after a predetermined period of time (e.g. 5-10 seconds), the system causes a warning sound and/or light alert to operate to remind the wearer to buckle the helmet at step 305. In an embodiment, this alert sound is different from the sound that is made when the buckle is fastened. At decision block 306, it is determined if the buckle is fastened in response to the audio/visual alert. If not, the system returns to step 305 and continues to present the alert. If the buckle is fastened, the system proceeds to step 307 where the time is stopped. In an optional embodiment, the system includes a mechanism to transmit a signal to a vehicle that permits operation only when the helmet is on and buckled.

In the wake state, the helmet determines whether motion indicative of activity is present by analyzing sensor data from accelerometer set 104. In one optional embodiment, a processor employing machine-learning or pattern-recognition algorithms classifies motion signatures as either safe or dangerous actions, such as cycling, skateboarding, or operating heavy equipment. Motion below a threshold or corresponding to non-hazardous activity (e.g., walking) does not trigger an alert unless the location corresponds to a designated danger zone. If dangerous motion or location is detected, the system proceeds to evaluate buckle status. This could be implemented in between steps 304 and 305 in an embodiment.

If the buckle circuit is open (unfastened), the system transitions to an alert state. In the alert state, audible warnings are issued via audio output devices 106 and/or visual indicators such as light 105 are activated to prompt the user to fasten the buckle or nearby persons to remind the user to fasten the buckle. The system remains in the alert state until the buckle circuit closes or the helmet is taken off the head. The system then transitions to the sleep state. When the user fastens the buckle in response to the alert, the system may stop the alert and provide the audio sound that indicates successful engagement of the buckle.

In an embodiment, the processor employs machine-learning classification to distinguish hazardous motion from non-hazardous motion. During operation, the accelerometer and gyroscope provide continuous numerical streams of multi-axis data, including translational acceleration, rotational velocity, and vibration frequency. The processor may compare incoming sensor patterns to stored reference sets representing bicycling cadence, braking deceleration, or terrain vibration. In another embodiment, a neural network classifier receives accelerometer magnitude vectors and GPS-derived velocity as input and outputs a probability that user activity corresponds to operation of a vehicle requiring protective headgear. A threshold probability value may be used to determine when alerts or lockouts are active. Classifier models may be developed from training datasets collected during normal riding or handling conditions.

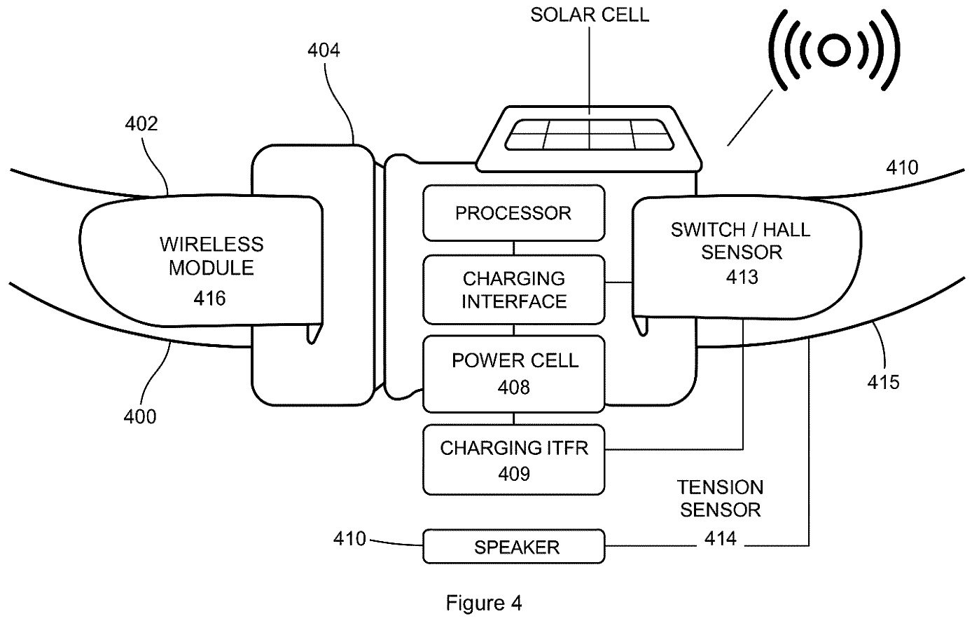

FIG. 4 shows in certain embodiments, most of the entire system—including the processor, sensors, sound, power, and switches—may be integrated within the buckle assembly itself, enabling new or retrofit applications to existing helmets or safety gear.

FIG. 4 illustrates a self-contained buckle module 400 in an embodiment. The buckle module 400 is configured to attach to a strap 402 on a first side and a strap 410 on a second side. The buckle module 400 includes a housing formed of opposing buckle portions that mechanically engage to secure the strap around a user. The buckle can be used anywhere and does not require it be used with straps, but wherever its features and functions will be useful.

Contained within the housing of buckle module 400 is an electronic control assembly 404. Electronic control assembly 404 includes a processor configured to execute logic for monitoring buckle state, sensor inputs, and alert conditions. The processor is electrically coupled to a wireless communication module 416, which is configured to transmit and receive data signals between the buckle module 400 and an external device, vehicle, or monitoring system.

A power cell 408 is disposed within the buckle module 400 and provides electrical power to the processor, wireless module 416, and other electronic components. In the illustrated embodiment, the power cell 408 is coupled to a charging interface 409. Charging interface 409 is configured to receive electrical energy from an external source. In one embodiment, the charging interface 409 is electrically coupled to a solar cell 407 positioned on an exterior surface of the buckle housing. The solar cell 407 is configured to generate electrical energy for charging the power cell 408 during exposure to ambient light. The rechargeable or non rechargeable and replacable power cell 408 may be a lithium-polymer pouch or solid-state microcell located within the buckle body

The buckle module 400 further includes a buckle state sensor 413 positioned adjacent to a mechanical engagement region of the buckle. In the illustrated embodiment, the buckle state sensor 413 comprises a switch and/or Hall-effect sensor configured to detect whether the buckle portions are mechanically engaged. The buckle state sensor 413 provides a signal to the processor indicative of whether the buckle is in a fastened or unfastened condition.

A tension sensor 414 is electrically coupled to the processor and is configured to detect tension in at least one of the straps 402 or 410. In one embodiment, the tension sensor 414 is coupled to a strap-embedded sensing element 415 disposed within strap 410. The strap-embedded sensing element 415 may comprise a strain-responsive conductor, piezoelectric element, or other tension-sensitive component that changes an electrical characteristic in response to strap elongation.

An audio output device 410, comprising a audio output device or piezo or sound emitting technology, is electrically coupled to the processor and is configured to generate audible alert signals when the processor determines that the buckle is unfastened, insufficiently tensioned, or otherwise in an unsafe condition. The processor may also control visual indicators (not shown) associated with the buckle module 400.

In operation, the processor within electronic control assembly 404 evaluates signals from the buckle state sensor 413, the tension sensor 414, and the wireless communication module 416 to determine whether to generate an alert, transmit a status message, or permit operation of an associated external device. The buckle module 400 operates as a self-contained monitoring and alert system that may be integrated into new protective equipment or retrofitted onto existing straps without requiring modification of the protective device shell.

The housing may be constructed of injection-molded thermoplastic such as ABS, nylon-glass composite, or polycarbonate, and may be sealed with ultrasonic welding or adhesive bonding to provide ingress protection against water exposure.

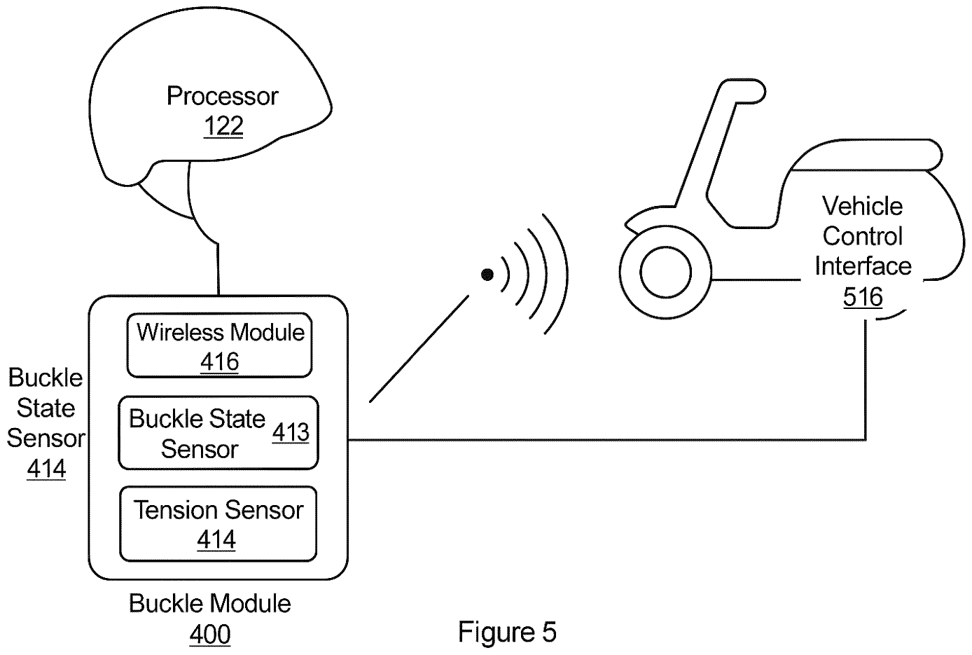

FIG. 5 illustrates a system architecture for controlling operation of a powered device based on buckle status in an embodiment. The system includes a protective device, such as a helmet 100, a buckle module 400, and a powered device having a vehicle control interface 516.

Helmet 100 includes a processor 122 configured to execute logic associated with determining whether the helmet is being worn and whether operational conditions are satisfied. Processor 122 may be located within the helmet shell or coupled to internal helmet electronics, and may communicate with buckle module 400 either directly or indirectly.

Buckle module 400 includes a wireless communication module 416 configured to transmit and receive data signals. Wireless communication module 416 may operate using Bluetooth Low Energy, LoRa, sub-GHz radio, Wi-Fi, or another short-range or low-power wireless protocol. Buckle module 400 further includes a buckle state sensor 413 configured to detect whether the buckle connectors are engaged. In certain embodiments, buckle state sensor 413 comprises a Hall-effect sensor, mechanical switch, or electrical continuity detector.

Buckle module 400 also includes a tension sensor 414 configured to detect tension in an associated strap. Tension sensor 414 may be implemented using a strain-responsive conductor, piezoelectric element, or other elongation-sensitive component embedded within or coupled to the strap. Signals from buckle state sensor 413 and tension sensor 414 are provided to the processor associated with buckle module 400 and may be transmitted via wireless module 416.

Vehicle control interface 516 is coupled to a powered device, such as an electric bicycle, scooter, construction machine, agricultural equipment, or powered tool. Vehicle control interface 516 may be electrically connected to propulsion, ignition, drive, or actuation circuitry of the powered device. Vehicle control interface 516 is configured to receive wireless signals from buckle module 400, either directly or through an intermediary controller.

In operation, vehicle control interface 516 may periodically broadcast a status request or authentication query. Buckle module 400 responds via wireless module 416 when buckle state sensor 413 indicates that the buckle is engaged and when tension sensor 414 indicates that strap tension meets a defined threshold. In response to receiving a valid acknowledgment, vehicle control interface 516 permits operation of the powered device. If an acknowledgment is not received, or if buckle state or tension criteria are not satisfied, vehicle control interface 516 may inhibit propulsion, ignition, or actuation of the powered device.

In certain embodiments, buckle module 400 transmits a periodic heartbeat signal at defined intervals, such as between 0.5 and 5 seconds. Vehicle control interface 516 maintains enabled operation only while the heartbeat signal is received within a timeout window. If the heartbeat expires or indicates a change in buckle state, vehicle control interface 516 may transition the powered device to a disabled, neutral, or reduced-power state.

In optional embodiments, processor 122 within helmet 100 participates in the control logic by confirming helmet-on-head status using presence or motion sensors and providing additional authorization data to buckle module 400 or directly to vehicle control interface 516. Communication between helmet 100, buckle module 400, and vehicle control interface 516 may be encrypted or include rolling authentication codes to prevent unintended activation.

FIG. 5 thus illustrates a system in which operation of a powered device is selectively enabled based on confirmation that protective equipment is worn and properly buckled, without requiring physical wiring between the helmet and the powered device.

### Operational Examples

In an embodiment, the system enables or disables a vehicle or powered device based on buckle state confirmation. The helmet may include a wireless communication module configured to exchange access tokens with a bicycle, e-bike, construction machine, or other powered equipment. During operation, the vehicle control interface may broadcast a request packet containing an identifier, and the helmet may respond only when the buckle is confirmed closed and tension criteria are met. A rolling authentication code or periodic “heartbeat” packet may be transmitted from the helmet to the powered device at intervals such as 0.5-5 seconds. If the heartbeat expires or the buckle transitions to open status, the powered device may remain disabled or transition to a reduced or neutral state until buckle closure is detected.

Example 1: Jeff is preparing to ride his bicycle home from school. Initially, the helmet is in the OFF state, as it is not on his head. When Jeff places the helmet on his head, the internal switch activates, transitioning the system to the ARMED state. Upon buckling the helmet, the system detects the secure buckle and enters the SAFE state. When Jeff arrives home and removes the helmet, the system transitions back to the OFF/Sleep state.

Example 2: Jeff begins another bike ride home from school. As before, the helmet is initially in the OFF/sleep state. Upon placing the helmet on his head, the system transitions to the ARMED state. Jeff, however, forgets to buckle the helmet. When the accelerometer technologies detect biking motion or a set amount of time has passed, the system enters the ALERT state and emits an audible warning. Annoyed by the beeping, Jeff stops to secure the buckle. The system then transitions from the ALERT state to the SAFE state. Once Jeff arrives home and removes the helmet, the system returns to the OFF/sleep state.

In one embodiment, the helmet is comprised of any lightweight and strong protective material, that satisfies regulatory and recommended requirements for helmets. The lights on the helmet can be coupled to the accelerometers and be made to flash or brighten in the manner of brake lights when deceleration is detected. The solar panels are used to charge the integrated batteries. A charging port (e.g. USB-C and the like) can be incorporated into the helmet for charging the batteries as well. The helmet and associated integrated components are water resistant or water proof to ensure the operation is different weather conditions.

In one embodiment, the operation of the helmet can incorporate machine learning, artificial intelligence, and neural networks to optimize the operation of the helmet.

In one embodiment, the accelerometers and/or an impact sensor can detect an accident and cause an alert to be sent, via cellular, LoRaWan or wifi depending on the embodiment.

In one embodiment, the system prevents operation of a vehicle, such as an e-bike, construction machinery, or any vehicle in which it is recommended that a helmet be worn. In addition, the system may prevent operation of heavy tools including jackhammers, chainsaws, and the like unless a safety helmet is detected as being buckled. This may be done by installing a shutoff on the machinery or vehicle, where the shutoff requires a signal from the helmet to turn on, and the signal is only provided when the helmet is secure.

The helmet, buckle assembly, and integrated electronics may be manufactured using water-resistant construction. Seams between outer shell and buckle housing may be bonded or gasketed to achieve ingress protection suitable for outdoor use. In one embodiment, electronic components are coated with conformal moisture-resistant material such as silicone or acrylic coating. Batteries may be enclosed in polymer pouches with strain relief to reduce stress during flexing. Helmet shells may be formed via injection-molded ABS, polycarbonate, carbon fiber composite, or any impact-approved protective material. Variations in material selection, thickness, and shock-absorbing liner type may be implemented as needed without altering system logic.

In an embodiment, tension sensing, buckle closure sensing, head-presence detection, and motion detection operate simultaneously. The processor may require confirmation of all conditions before enabling vehicle operation, or may validate subsets of conditions depending on safety policy settings. Sensor thresholds, timing intervals, and classification outputs may be user-adjustable or remotely configured through wireless communication.

Thus, a method and apparatus for an improved helmet has been described.

What is claimed is:

1. A smart buckle system comprising:
a first buckle connector configured to mechanically engage a second buckle connector;
an electrical conductor disposed within at least one of the buckle connectors, forming a circuit that is open when the buckle connectors are disengaged and closed when the buckle connectors are engaged;
a buckle sensor configured to detect the open or closed state of the circuit;
one or more environmental, presence, GPS, switch or motion sensors is configured to detect at least one of motion, orientation, location or presence of a user;
a processor coupled to the buckle sensor and the one or more sensors; and comprising an alert device controlled by the processor and configured to generate an audible and/or visual alert when the processor determines that the buckle is open under a detected motion, presence condition or location; and configured to generate a confirmation audible and/or visual alert when the processor determines that the buckle is securely fastened.

2. The smart buckle system of claim 1, wherein the one or more sensors comprise at least one of an accelerometer, switch, gyroscope, proximity sensor, GPS antennae or time-of-flight sensor.

3. The smart buckle system of claim 1, wherein the alert device comprises at least one miniature audio output device and/or at least one indicator light integrated into the buckle housing.

4. A protective device comprising a strap and the smart buckle system of claim 1, wherein the alert device provides a reminder when the buckle is unfastened while the device is worn.

5. The smart buckle system of claim 1, wherein the audible alert comprises a pattern of beeps and pauses that vary based on the type of unsafe condition detected.

6. The smart buckle system of claim 1, further comprising a rechargeable power source coupled to one or more solar panels integrated into or near the buckle housing.

7. The smart buckle system of claim 1, wherein the processor executes a machine-learning algorithm trained to distinguish dangerous activities from non-dangerous activities based on data from the one or more sensors.

8. The smart buckle system of claim 1, further comprising a wireless communication module configured to transmit buckle status, locations, motion data, or alert information to an external device, software application or remote network.

9. The smart buckle system of claim 1, wherein the processor determines that the buckle is open while the buckle system is in a designated hazardous location and activates the alert device.

10. The smart buckle system of claim 1, wherein the processor is configured to enable or disable operation of an external powered device when the buckle is respectively closed or open.

11. The smart buckle system of claim 1, wherein the processor is configured to detect an impact event and transmit an emergency signal containing location information via the wireless communication module.

12. The smart buckle system of claim 1, wherein the smart buckle is a self-contained module attachable to or integrable within an existing strap or fastening mechanism of a helmet, car seat, harness, vest, or other protective equipment.

13. The protective device of claim 12, wherein the protective device is a helmet, safety harness, or child car seat.

14. The protective device of claim 12, wherein the processor communicates buckle status to a network or team monitoring system to confirm all users are buckled prior to entering a hazardous area.

15. The protective device of claim 12, wherein the smart buckle enables access, power or ignition of an associated vehicle or machine only when the buckle is securely fastened.

16. The protective device of claim 12, wherein an impact detected by the smart buckle triggers transmission of a location alert to a third party.

17. A method of reminding a user to secure a safety buckle using the smart buckle system of claim 1, comprising:
detecting, by the buckle sensor, an open or closed connection between first and second buckle connectors;
detecting, by one or more switches, motion or presence sensors, at least one of motion, orientation, or user presence;
determining, by the processor of the smart buckle system, that the buckle is open under a motion or presence condition; and
activating an audible and/or visual alert until the buckle is closed.

18. The method of claim 17, further comprising detecting placement of the protective device using a proximity, infrared, or pressure sensor.

19. The method of claim 17, further comprising classifying motion as dangerous or non-dangerous using machine-learning analysis of accelerometer and GPS data.

20. The method of claim 17, further comprising transmitting buckle status or incident alerts wirelessly to an external device or monitoring system.
